(19) United States
(12) Patent Application Publication
(10) Pub. No.: US 2007/0039675 A1
(43) Pub. Date: Feb. 22, 2007

(54) Fluoropolymer-Based Material in Tape or Varnish Form Suitable for Laser Marking

(75) Inventor: Chor Keung YEUNG, Chaudenay (FR)

Correspondence Address: OLIFF & BERRIDGE, PLC, P.O. BOX 19928, ALEXANDRIA, VA, 22320, US

(73) Assignee: Compagnie Plastic Omnium, Lyon (FR)

(21) Appl. No.: 11/552,088

(22) Filed: Oct. 23, 2006

Related U.S. Application Data
(62) Division of application No. 10/619,589, filed on Jul. 16, 2003.

(30) Foreign Application Priority Data
Jul. 22, 2002 (FR) 02 09282

(51) Int. Cl. H01B 13/26; C08K 5/08; C08K 5/07

(52) U.S. Cl. 156/53; 524/358; 524/359

(57) ABSTRACT

The present invention relates to a fluoropolymer-based coating material in tape or varnish form suitable for laser marking and containing as additive from 0.5% to 5% by weight of at least one polyimide comprising repeating units which include at least one group Ar—X—Ar′, in which Ar and Ar′ represent independently an optionally substituted monovalent or divalent aryl group and X represents a —CO— or —S— group, the said polyimide being essentially free from heteroatoms or heteratomic groups other than —S— and other than the imide groups.

This is a Division of application Ser. No. 10/619,589 filed on Jul. 16, 2003. The disclosure of the prior application is incorporated herein by reference in its entirety.

The invention relates to a fluoropolymer-based coating material in tape or varnish form suitable for laser marking.

It is known that perfluorinated or near-perfluorinated polymers, such as poly(tetrafluoroethylene) or PTFE, or else fluorinated ethylene-propylene copolymers are chemically inert materials having good electrical insulation properties with the ability to withstand high temperatures continuously.

Fluoropolymers of this kind are used in the manufacture of coatings for electrical cables, particularly in the form of complex-structure cable coating tapes.

For the identification of cables it is desirable to mark them with a laser beam so as to produce identification inscriptions on the surface of the cable in the form of indelible marks with an appropriate contrast.

Fluoropolymers, however, are not suited to laser marking since the visibility of the marks to which they give rise is relatively low.

It is known to incorporate additives which change colour following irradiation by a laser beam into the fluoropolymers, so that the visible marks appear in the irradiated areas, by contrast with the unirradiated areas. Titanium dioxide, for example, is used, whose colour turns from white to grey in the impingement areas of a UV laser (one which emits in the ultraviolet). The contrast obtained, however, does not exceed approximately 60% and is not stable over time: the mark ages and the contrast may go down to below 40%.

It is recalled that the contrast is the percentage defined by (1-Lm/LG)×100, where Lm and LG are, respectively, the luminance of the mark and the luminance of the ground.

Proposals have likewise been made to add certain organic additives sensitive to the UV laser to the fluoropolymers, allowing more durable marks to be obtained. The use of fluoropolymers such as PTFE, however, necessitates a phase of sintering at a temperature of the order of 360° C., and the organic additives generally do not withstand temperatures greater than 300° C.

It has now been found that the incorporation of certain polyimides in the fluoropolymers allows a substantial improvement in the UV laser markability, with an high contrast. Patent application EP 0 367 629 recommends adding various conjugated aromatic polymers such as polyketones, polyetherketones, polysulphones, polyethersulphones, polyimides, poly(phenylene sulphides) and polyetherimides as additives permitting an improvement in laser marking. No indication, however, is provided regarding the structure of the polyimides which it might be possible to use, and no example of use of such polyimides is given. In fact, as shown in the experimental section hereinafter, many known polyimides and polyetherimides are unsuited to laser marking.

It has now been found that certain polyimides of specific structure are of great interest for the acquisition of coatings markable by UV laser with a high contrast.

The invention therefore provides a fluoropolymer-based coating material in tape or varnish form suitable for laser marking and containing as additive from 0.5% to 5% by weight of at least one polyimide comprising repeating units which include at least one group Ar—X—Ar′, in which Ar and Ar′ represent independently an optionally substituted monovalent or divalent aromatic group and X represents a —CO— or —S— group, the said polyimide being essentially free from heteroatoms or heteratomic groups other than —S— and other than the imide groups.

In the present application aromatic groups or else aryl groups are groups which possess one or more benzene, naphthalene or anthracene nuclei.

Among these materials mention will be made in particular of those for which the said —CO— group is present in a divalent or tetravalent group of formula I
Ar—CO—Ar′ (I)
where Ar and Ar′ represent each independently an optionally substituted monovalent or divalent aryl group, and in particular of those for which the said —CO— group is present in a divalent or tetravalent aromatic group of formula II or III 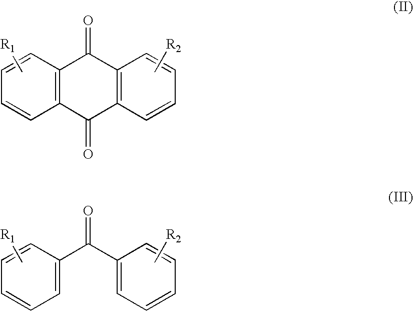
where R₁ and R₂ represent independently H or one or more substituents.

Among the polyimides which can be used in accordance with the invention mention would also be made of those containing an —S-group present in a divalent or tetravalent aromatic group of formula IV
Ar [symbol] S—Ar″ [symbol] ₘS—Ar′ (IV)
in which Ar and Ar′ each represent a monovalent or divalent aryl group, Ar″ is an arylene group, m is the number zero or an integer 1 or 2, and the groups Ar, Ar′ and Ar″ are optionally substituted; among these compounds mention would be made of those in which the —S— group is present in a divalent or tetravalent aromatic group of formula (V) 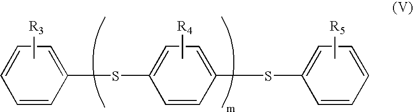
in which R₃, R₄ and R₅ represent independently H or one or more substituents and m is a number 0, 1 or 2,
or of formula VI

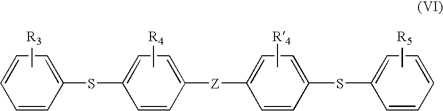

in which R₃, R₄ and R₅ are defined as above, R′₄ represents H or one or more substituents, and Z is a covalent bond or a —(CH₂)—, —CH(CH₃)— or —C(CH₃)₂— group.

The polyimides which can be used in the coating material of the invention are in particular those which contain units of formula VII 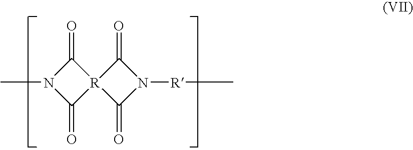
in which R represents an optionally substituted tetravalent aromatic group and R′ is an optionally substituted divalent aromatic group and in which at least one of the groups R and R′ contains at least one group Ar—X—Ar′ as defined above.

Among the polyimides which can be used mention will be made in particular of those for which R represents at least one of the tetravalent groups of formulae IIa, IIIa, Va or VIa 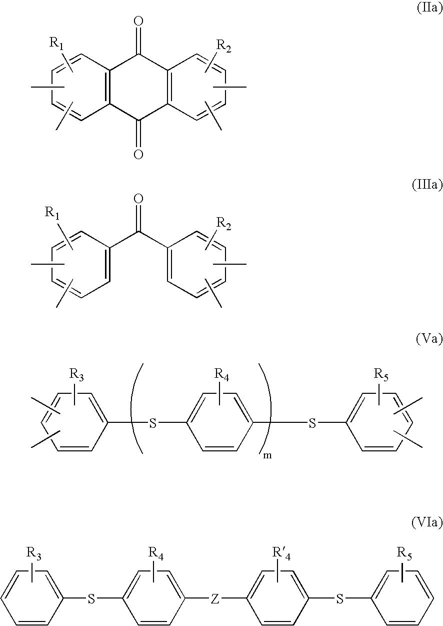
where R₁, R₂, R₃, R₄, R₅ and R′₄ represent independently H or 1 or more substituents Z represent a covalent bond, —CH₂—, —CH(CH₃)— or —C(CH₃)₂—, and the free valencies are positioned ortho with respect to one another;
and also those for which R′ represents at least one of the divalent groups of formula IIb, IIIb, Vb or VIb 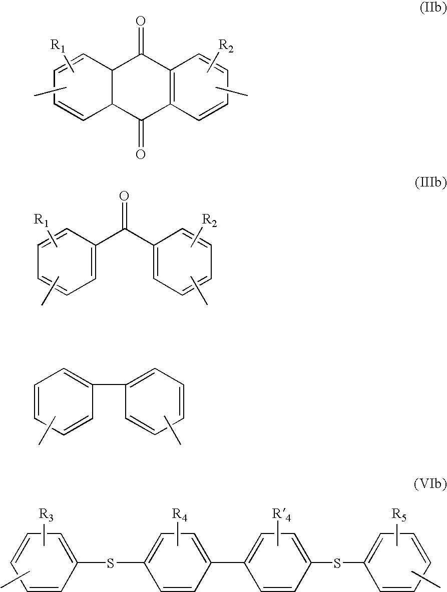
where R₁, R₂, R₃, R₄, R₅, R′₄ and Z are defined as above.

It is possible to use in particular the polyimides of formula VII in which either the groups R, or the groups R′ contain groups Ar—X—Ar′ as defined in any one of Claims 1 to 4 and the other groups (either R′, or R, as appropriate) do not contain such groups. These other groups are, in particular, divalent (in the case of R′) or tetravalent (in the case of R) aromatic groups containing cyclic groups derived from benzene or from naphthalene which are optionally substituted by halogens, lower alkyls and lower haloalkyls. The said other groups have, for example, at least one of the following structures: 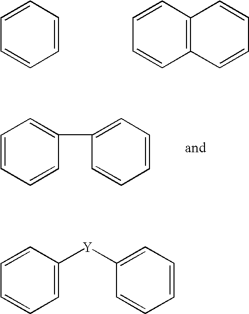
in which Y represents —CH₂—, —CH(CH₃)— or —C(CH₃)₂— and the rings are optionally substituted by halogens, lower alkyls or lower haloalkyls. It will be appreciated that, when the group R is of the formula VII, the corresponding structures are tetravalent, analogously to the structures IIa, IIIa, Va and VIa indicated above, and that, when the group R′ is of the formula VII, these structures are divalent, analogously to that indicated above for the formula IIb, IIIb, Vb or VIb.

Generally speaking, the substituents which are optionally present on the aryl groups of the polyimides used in accordance with the invention are, in particular, halogens (especially fluorine or chlorine), lower alkyls (for example methyl, ethyl, n-propyl or isopropyl), or lower haloalkyls, especially fluoroalkyls, including perfluoroalkyls, for example the —CF₃ group.

In the present application a lower alkyl denotes an alkyl having from 1 to 5 carbon atoms and in particular from 1 to 3 carbon atoms.

It will be appreciated that, in the polyimides of formula VII, the groups R and R′ (or some of the groups R and some of the groups R′) may both contain groups Ar—X—Ar′.

The polyimides which can be used in accordance with the invention are known products or can be prepared by known processes which consist primarily in reacting an intramolecular dianhydride derived from a tetracarboxylic aromatic acid of formula R(COOH)₄ with a diamine of formula R′(NH₂)₂ or a corresponding diisocyanate; see, for example, the processes described in U.S. Pat. No. 5,066,760 and U.S. Pat. No. 3,847,867.

It is possible, for example, to use the polyimide P84 from the firm HP Polymer, which corresponds to a polymer of the formula VII with R representing a group of type IIIa (where R₁ and R₂ represent H), and R′ represents the group

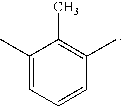

It is also possible to use the polyimide P84 HT from the same firm, which is a copolymer corresponding to the formula VII with tetravalent groups R of formula IIIa (with R₁=R₂=H), tetravalent groups R of formula 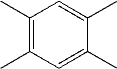
and the group R′ corresponding to the formula

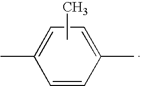

In order to incorporate the polyimide into the fluoropolymer the polyimide in the form of a powder with particle sizes, for example, of from 2 to 12 μm is mixed into the fluoropolymer, which is itself in powder form.

If it is desired to colour the coating it is possible to add, in addition, a white or coloured pigment to the material, for example TiO₂ or a titanate.

The material of the invention may in particular be formed into a tape intended for winding on the surface to be laser marked, for example the surface of an electrical cable.

Such a tape may be obtained in particular by the process known as lubricated extrusion, which involves mixing the composition based on fluoropolymer powder, polyimide and, where appropriate, pigment in a mixture with a lubricant (for example that sold by Exxon under the name Isopar) to produce a lubricated mixture which is subsequently compacted and extruded through an appropriate die to give the material in the desired form, for example a tape, which is subsequently calendered between two rolls, with or without drawing, to give a thin tape, and the lubricant is removed, for example by evaporation.

The coating material of the invention may likewise be produced in the form of a varnish, an additived aqueous dispersion of fluoropolymer, which is applied, for example, by dipping followed by drying of the product which it is desired to coat.

Following application the coating material is baked at a temperature higher than the sintering temperature.

It has been observed that the incorporation of polyimides into fluoropolymers increases the risk of electrical arc tracking. It has been found, however, that in those cases where the phenomenon of electrical arc tracking is considered a threat it is possible to prevent such tracking by adding to the coating material certain metal salts or oxides which have the property of inhibiting electrical arc tracking. For example, from 0.5% to 3% of such an inhibitor can be added, which can be selected in particular from alumina, zinc oxide and zinc borate.

These metal salts or oxides are added for example in the form of powders having particle sizes of from 1 to 10 μm.

The invention extends to any manufactured product coated with a coating material as defined above, for example an electrical cable.

The invention likewise relates to the use as electrical arc tracking inhibitor in fluoropolymer-based coatings comprising as additive at least one polyimide as defined above of a filler selected from alumina, zinc oxide, zinc borate and mixtures thereof, in particular at from 0.5 to 3% by weight relative to the weight of the said coating.

The examples which follow illustrate the invention.

### EXAMPLE 1

A basic PTFE-based composition was prepared containing 1% of polyimide P84.

This composition was used to produce, by lubricated extrusion, a tape having a thickness of 76 μm.

The tape obtained was used for covering an electrical cable coated with an underlayer of polyimide (sold under the name Kapton by Du Pont de Nemours). The PTFE coating is sintered at a temperature of 380° C.

Marking tests were conducted with a UV laser (energy density 0.8 J/cm²).

A mark is obtained having a contrast of 82%.

### EXAMPLE 2

The above procedure is repeated, replacing the polymer P84 by the copolymer P84 HT.

### EXAMPLE 3

The procedure of Example 1 is repeated but with the further addition to the starting composition of 1% by weight of alumina (reference BRH-15, supplier: Alumines Durmax).

The alumina can be replaced by zinc oxide or zinc borate.

### EXAMPLE 4

The procedure of Example 1 is repeated but with the further addition to the composition of 0.5% by weight of TiO₂ particles.

### EXAMPLE 5

Comparison tests between tapes containing different fillers were carried out in order to evaluate their performance in terms of resistance to electrical arc tracking.

The polyimide additive is P84 HT.

Tapes of the following compositions were used:

a) 100% PTFE tape

b) PTFE tape containing 0.8% polyimide

c) PTFE tape containing 0.8% polyimide and 0.4% alumina

d) PTFE tape containing 0.8% polyimide and 0.8% alumina

e) PTFE tape containing 0.8% polyimide and 1.2% zinc borate.

22-gauge cables were coated by covering with the above tapes for the test (dry test) on resistance to electrical arc initiation and tracking in accordance with draft European standard NF EN 3475-604. The evaluation of the level of loss on the 18 test specimens (bundles of seven cables) tested at six electrical current intensities (three per intensity) in each type of tape is given in Table 1 below:

TABLE 1

| Tape | % loss |
|---|---|
| (a) | 0 |
| (b) | 15 |
| (c) | 8 |
| (d) | 1 |
| (e) | 3 |

### EXAMPLE 6

Marking tests on various polyimides were conducted with an excimer laser of wavelength 308 nm, energy 1 J/cm².

The polyimides investigated were as follows:
poly(4,4′-oxydiphenylenepyromellitimide) film sold under the name Kapton by Du Pont de Nemours,
polyimide Vespel, sold by Du Pont de Nemours, having the same structure as Kapton, but in powder form,
polyimide Apical, sold by Kaneka.
   The polyimide Apical has the same structure as Kapton, the only difference being that Kapton is cured chemically whereas Apical is cured thermally.
Polyimide Aurum, sold by Mitsui Toatsu.
   The structure of the polyimide Aurum, described with reference to the formula VII, would correspond to the case where R is a tetravalent phenyl radical and R′ is a group
   —(m-C₆H₄)—O—(p-C₆H₄)₂—O—(m-C₆H₄)—.
Polyetherimide Ultem (General Electric), whose structure, described with reference to the formula VII, would correspond to the case where R is a radical like that of the formula VIa above with R₃=R₄=R′₄=R₅=H, and Z=—C(CH₃)₂—, but whose —S—heteroatoms have been replaced by —O—, and R′ is an -m-C₆H₄— group.

The results are summarized in Table 2 below:

TABLE 2

| Polyimide | Markability | Contrast |
|---|---|---|
| Kapton | no | — |
| Vespel | no | — |
| Apical | no | — |
| Aurum | no | — |
| Ultem | no | — |
| P84 | yes | high |
| P84 HT | yes | high |

These tests show that the polyimides and polyetherimides are not all suited to laser marking. Only the polyimides as defined in the present specification were found suitable for laser marking.

1. A method of fabricating a coating tape suitable for laser marking comprising
providing a mixture of a fluoropolymer-based coating material suitable for laser marking, containing as an additive from 0.5% to 5% by weight of at least one polyimide comprising repeating units which include at least one group Ar—X—Ar′, in which Ar and Ar′ represent independently an optionally substituted monovalent or divalent aryl group and X represents a —CO— or —S— group, the polyimide being essentially free from heteroatoms or heteratomic groups other than —S— and other than the imide groups, and
extruding the mixture by lubricated extrusion into a tape.

2. The method according to claim 1, wherein in the additive at least 50% of the units of the polyimide include at least one group Ar—X—Ar′.

3. The method according to claim 1, wherein the additive of the mixture has at least one of the following features:
the —CO— group is present in a divalent or tetravalent group of formula I
Ar—CO—Ar′ (I)
wherein Ar and Ar′ represent each independently an optionally substituted monovalent or divalent aryl group;
the —CO— group is present in a divalent or tetravalent aromatic group of formula II or III 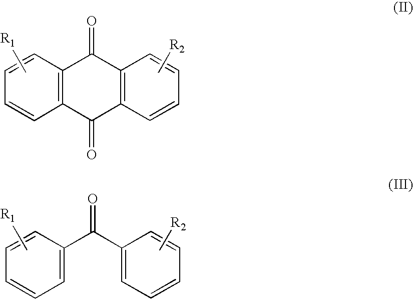
wherein R₁ and R₂ represent independently H or one or more substituents.

4. The method according to claim 1, wherein the additive has at least one of the following features:
the —S— group is present in a divalent or tetravalent aromatic group of formula IV
Ar [symbol] S—Ar″ [symbol] ₘS—Ar′ (IV)
wherein Ar and Ar′ each represent a monovalent or divalent aryl group, Ar″ is an arylene group, m is the number zero or an integer 1 or 2, and the groups Ar, Ar′ and Ar″ are optionally substituted;
the —S— group is present in a divalent or tetravalent aromatic group of the formula V 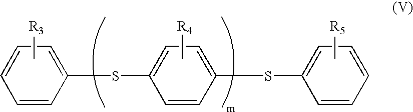
wherein R₃, R₄ and R₅ represent independently H or one or more substituents and m is a number 0, 1 or 2,
or of formula VI 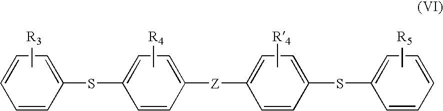
wherein R₃, R₄ and R₅ are defined as above, and R′₄ represents H or one or more substituents, and Z represents a covalent bond or a —CH₂—, —CH(CH₃)— or —C(CH₃)₂— group.

5. The method according to claim 1, wherein in the additive, the polyimide includes units of formula VII 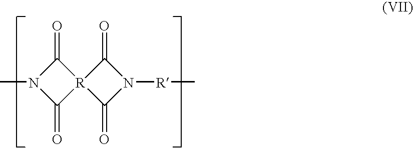
wherein R represents an optionally substituted tetravalent aromatic group and R′ is an optionally substituted divalent aromatic group, and wherein at least one of the groups R and R′ includes at least one group Ar—X—Ar′.

6. The method according to claim 5, wherein in the additive, R represents at least one of the tetravalent groups of formula IIa, IIIa, Va or VIa 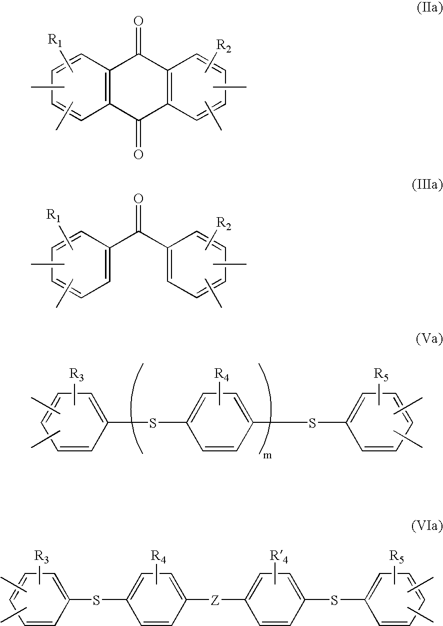
wherein R₁, R₂, R₃, R₄, R₅ and R′₄ represent independently H or one or more substituents, Z represents a covalent bond or a —CH₂—, —CH(CH₃)— or —C(CH₃)₂— group, and the free valencies are positioned ortho with respect to one another.

7. The method according to claim 5, wherein in the additive, R′ represents at least one of the divalent groups of formula IIb, IIIb, Vb or VIb 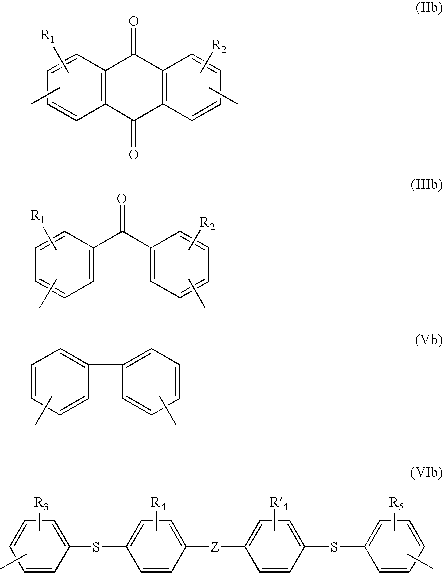
wherein R₁, R₂, R₃, R₄, R₅ and R′₄ represent each independently H or one or more substituents, and Z represents a covalent bond or a —CH₂—, —CH(CH₃)— or —C(CH₃)₂— group.

8. The method according to claim 5, wherein in the additive, one of the R or R′ group includes group Ar—X—Ar′, and the other of the R′ or R group, as appropriate, does not contain such group.

9. The method according to claim 8, wherein in the additive, the other of the R′ or R group, as appropriate, is a divalent (in the case of R′) or tetravalent (in the case of R) aromatic group containing at least one cyclic group derived from benzene or from naphthalene, optionally substituted by halogens, lower alkyls and lower haloalkyls.

10. The method according to claim 9, wherein in the additive, the other of the R′ or R group, as appropriate, has at least one of the following structures: 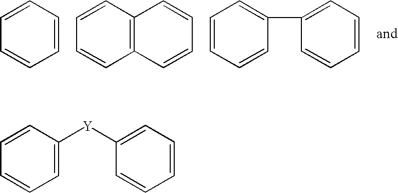
wherein Y represents —CH₂—, —CH(CH₃)— or —C(CH₃)₂— and the rings are optionally substituted by halogens, lower alkyls or lower haloalkyls.

11. The method according to claim 1, wherein the mixture further comprises from 0.5% to 3% of a metal salt or oxide which inhibits electrical arc tracking.

12. The method according to claim 11, wherein in the mixture, the electrical arc tracking inhibitor is selected from alumina, zinc oxide and zinc borate.

13. The method according to claim 1, wherein the mixture has at least one of the following features:
it further comprises a white or colored pigment; and
the fluoropolymer is PTFE.

14. The method according to claim 1, wherein the mixture has at least one of the following features:
the mixture further comprises a lubricant;
the mixture further comprises a white or colored pigment; and
the PTFE is a powder form.

15. The method according to claim 14, wherein the mixture further comprises a lubricant, and wherein the method further comprises
subjecting the extruded material to calendaring; and
removing the lubricant from the extruded material by evaporating the lubricant.

16. The method according to claim 1, further comprising applying the tape to electric cables to cover the electrical cables.

17. A cable coated by a material obtained by the method according to claim 1.

18. The cable according to claim 17, wherein the material extruded in tape form is coated onto the cable by winding.
